(19) United States
(12) Patent Application Publication
(10) Pub. No.: US 2006/0155454 A1
(43) Pub. Date: Jul. 13, 2006

(54) Method for improving the handling characteristic of a vehicle during emergency braked driving

(75) Inventors: Torsten Herrmann, Frankfurt/Main (DE); Mahan Poursedighi, Frankfurt/Main (DE); Holger Schafferus, Magdeburg (DE); Jurgen Woywod, Morfelden (DE); Dieter Burkhard, Bingen-Budelheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG, Frankfurt/Main (DE)

(21) Appl. No.: 10/528,531

(22) PCT Filed: Aug. 12, 2003
(86) PCT No.: PCT/EP03/50375

§ 371 Date: Oct. 17, 2005

(30) Foreign Application Priority Data
Sep. 25, 2002 (DE) 102 44 557.5

(51) Int. Cl. G06G 7/76

(52) U.S. Cl. 701/70; 701/72

(57) ABSTRACT

The invention relates to a method for improving the handling characteristic of a vehicle during partially braked driving. The invention is characterized by a driving stability regulation device for correcting or regulating deviations from a desired lane, said device being configured in such a way that the start and the conclusion of an activated regulation situation is carried out depending upon conditions which are detected in accordance with straight-ahead driving conditions and cornering.

### TECHNICAL FIELD

The invention relates to a method for improving the handling characteristic of a vehicle during partially-braked driving.

### BACKGROUND OF THE INVENTION

For several years, cases have already been known in which vehicles of a prototype series tend to exhibit critical driving behavior in the partially-braked area. This effect, whose causes may include the elastic-kinematic properties of the vehicle, can lead to a decrease in driving comfort and even to critical situations, if the conditions are unfavorable. Moreover, in general, every vehicle, due to different vertical forces and friction values or friction pairing in the brake (different coatings), an asymmetric generation of longitudinal force portions can occur in the partially-braked area. These forces may result in a yaw moment causing uncomfortable even critical driving behavior of the vehicle.

Vehicles with such a chassis or brake configuration influence the driving behavior during the braking process to the effect that the vehicle does not stay in the desired driving lane during the braking process. The vehicle follows a course which is determined by the chassis and/or brake configuration. In this case one speaks of the “pulling” of the vehicle. This pulling may, represent a stable driving status, but it nevertheless deviates from the driver's intention. Using the methods which have been used to date to optimize the braking process one can, however, not compensate for such a behavior. ABS (anti-lock brake system), for example, a regulation of individual wheels influences the braking in a wheel brake as a function of the driving behavior of this wheel. The electronic brake force distribution (EBD), which is contained in the ABS, automatically regulates the brake pressure of the back axle and it keeps the vehicle stable with the best possible braking of the back axle. EBD adapts the brake force of the back wheels to the forces of the front wheels and thus prevents both underbraking and also overbraking of the back wheels. EBD uses the components of the ABS for the pressure modulation of the back wheel brakes, for each individual wheel.

Using this method, however, moments about the vertical axis of the vehicle cannot be generated, because the wheels in each case are controlled only individually after the brake skidding, but not as a function of the vehicle course.

In addition, there is no correction of the state by an ESP (electronic stability program), because the conditions trigger an ESP intervention and the regulation thresholds are reached too late, or not at all. These ESP conditions and regulation thresholds could also not be changed or lowered appropriately, because the required interference distance for incorrect regulations must be maintained.

If there is an ESP intervention, which, in cases of unstable driving conditions, generates an additional yaw moment, which acts against the turning of the vehicle to compensate for the turning of the vehicle about the vertical axis by increasing or decreasing the brake pressure individually in a wheel brake, changes in delay occur, which are observed by the driver. Additional drawbacks are the filling of the low pressure reservoir during the pressure decrease, as well as the opening of the reversing valve during the activated pressure increase, and the associated filling of the low pressure absorbers, which can be felt in the brake pedal. In addition, in the braking pressure range, where the regulation or adjustment of the brake device occurs, switchable orifice for the inlet valves can be switched, which leads to pressure increase gradients which differ from the pressure increase gradients of switchable orifices which are not switched.

Furthermore, in the case of a partially-braked (still no ABS activity) driving in a curve with a motor vehicle, in particular after the first occurrence of vehicle instabilities due to oversteering, which require steering actions by the driver for stabilization, which may exceed the driver's capacities. The primary causes for this behavior are the shift of the wheel load toward the front axle, which tends to move the capacity for lateral force transfer to the front. As a result, the described tendency to oversteering occurs. In principle, this effect can be supported by the following boundary conditions:
a) brake status (use of a portion of the transferable force already for the braking force)
b) unfavorable, already statically present, axle load distribution toward the front axle (tends to occur more with front-drive vehicles)
c) vehicles with back axle drive, because most of the drag moment of the motor in the superposed push status shifts the back axle slightly into a skidding status which in turn requires a portion of the transferable lateral force potential.

The mentioned instabilities associated with oversteering occur particularly in the braking status, because, as a result of the brake force distribution in this area, no yaw moment is transferred to the vehicle structure, to counteract the oversteering tendency. If, on the other hand, the driver continues to increase the brake pressure, then he/she reaches the non-positive limit in the tire/pavement system and, as a result, the ABS is activated. Because the transferable force on the side located within the curve is smaller due to the conferred transverse dynamics, the yaw moment is generated, which acts against the oversteering tendency. Therefore, the stability problems of the vehicle are usually eliminated, as soon as the driver applies excessive brake power in the partially-braked area.

For systems, which are intended to achieve vehicle stabilization in the mentioned partially-braked area, there is thus the possibility of using a pressure modulation similar to the one obtained with activated ABS, namely an activated pressure decrease at the curve-interior wheels, already in the partially-braked area. In principle, this is already achieved with the known ESP function. However, the ESP regulation presents the following drawbacks:
a) The ESP regulator is too insensitive (start thresholds too high) for oversteering disturbances, which tend to accumulate in the lower dynamic range (the result is an insufficient effect).
b) An uncomfortable overall impression is produced (often activated pressure increase is required with the associated valve and pump activity has a negative effect on pedal and noise comfort).
c) Through the ESP function indicator lamp, the driver also receives an additional return message in the case of interventions which merely represent driver assistance.

Therefore, it would be desirable, independently of the cause which results in a deviation from the desired driving course, to provide a method or a regulation which, by targeted interventions of the braking system, reduces the yaw motion of the vehicle for any path and at any speed to a degree which is comfortable for, or easily controllable by, the driver.

In EP 0 482 374 A1, an electro-pneumatic brake device for commercial vehicles and buses is described, which presents an electrical brake encoder as well as an electrical control device, which is equipped for processing brake signals and also for processing the signals of sensor signals of a steering system. In the case of a control, effected by the brakes, of the pressure control values which precede the brake cylinders, to remove by regulation the steering moments, the steering sensor signals should also be taken into account. In the process, the braking device determines the correction pressures exclusively in the case of straight-ahead driving.

### BRIEF SUMMARY OF THE INVENTION

The invention is based on the problem of providing a method to improve the handling-characteristic of a vehicle during partially-braked driving.

According to the invention, this problem is solved by a method to improve the handling characteristics of a vehicle during partially-braked driving, by designing a driving stability regulation for the correction or regulation of deviations from a desired driving lane in such a manner that the start of an activated regulation situation and the exit from an activated regulation situation occur as a function of conditions, which are determined depending on whether straight-ahead driving or cornering conditions occur.

By the method, a regulation situation is recognized as a function of whether the vehicle is driving straight ahead or in a curve. It is only after the regulation situation has been recognized that the deviation from the desired driving lane of the vehicle during the braking process is determined and that the deviation between the desired driving lane and the lane through the vehicle moves is corrected, as a function of the result of the determination, if the deviation exceeds at least a threshold value. It is preferred to carry out the method in a vehicle with ESP driving stability regulation, so that the threshold value can be a modified ESP threshold value. The method allows a reliable detection of the driving situation which is to be changed on the basis of the deviation of the ESP vehicle model, in a new range. Here, an independent ESP regulator with more sensitive thresholds and an intervention strategy without activated pressure increase is used. The pump activation is avoided almost completely and no ESP function light is activated. Thus, the regulator has the property of acting earlier and to a large extent without the driver noticing it. During the entire regulation activities, the driver thus advantageously does not receive any haptic, optical or acoustical return messages (pedal, lamp, signal tone).

Additional advantages of the low dynamic ESP (LDE) method are:
Robustness against incorrect detections or disturbances.
Optimized valve activity with the goal of actuation control as needed.
Selective pump actuation only in case it is needed (inclusion of the low pressure reservoir model).
Harmonic interaction with other subsystems such as ESP, ABS, EBD and ESBS.

The method advantageously presents the following steps: determination of internal and external magnitudes and statuses which represent the handling characteristics and the driving in lanes of the vehicle, determination of an activated regulation situation or of the start of a regulation as a function of straight-ahead driving conditions or cornering, taking into consideration the internal and external magnitudes and statuses, and correction or regulation of deviations from a desired driving lane by setting or modifying the adjusted braking pressure, when at least one threshold value has been exceeded, which is determined as a function of rotation about the vertical axis of the vehicle.

Advantageously, the low dynamic ESP (LDE) is used to provide a method which, independently of the cause of the pulling of the vehicle, reduces the yaw motion of the vehicle, by means of targeted interventions on the wheel-brakes of the brake system, at any speed, to a level which can be controlled by the driver.

It is advantageous to compare the internal and external magnitudes with threshold values, and to carry out an evaluation of the statuses, regardless of whether the statuses of the vehicle stability regulation are activated or not activated.

To determine the start or end of a regulation situation, it is advantageous to take into account, as internal and external magnitudes and states, the steering angle (δ), the steering angle speed (δ), the braking pressure (pₘₐᵢₙ), the vehicle speed (ν), the lateral inclination angle (α), the lateral acceleration (α_{actual}), the radius of curvature and the regulation statuses of a vehicle stability regulation.

The threshold value, which is determined based on the rotation about the vertical axis of the vehicle, and which must be exceeded for the correction or regulation of deviations from a desired driving lane by setting or modifying the adjusted braking pressure, is determined advantageously based on the straight-ahead driving conditions or cornering. Advantageously, the threshold value (S_{ESP}) of an ESP driving stability regulation is formed according to ESP driving stability-criteria and modified, in the case of straight-ahead driving conditions using a first correction factor, and in the case of cornering using a second correction factor (k_{STRAIGHT 1} k_{CURVE 2}).

As conditions for the detection of the start of a regulation situation, it is provided that, in the case of partially-braked straight-ahead driving conditions, the start Gᵢₙ of the regulation occurs according to the relation Gᵢₙ=ƒ(δ, \dot{δ}, pₘₐᵢₙ, ν, α), if one or more of the following conditions are satisfied.
ESP is not activated.
ABS is not activated.
Straight-ahead driving conditions have been detected.

Furthermore, as additional advantageous condition for the detection of the start of a regulation situation, it is provided, that in the case of partially-braked straight-ahead driving, the start of the regulation occurs, if several of the following conditions are satisfied:
δ<k degree, δ<k₁ degree/s, pₘₐᵢₙ<k₂ bar, ν<k₃ km/h,
α<k₄ degree,
with the threshold values k to k₄.

As additional conditions for the detection of the start of a regulation situation, it is provided that, in the case of partially-braked cornering, the start Kᵢₙ in the regulation occurs according to the relation Kᵢₙ=ƒ(δ, δ, pₘₐᵢₙ, ν, a, α_{actual}) if one or more of the following conditions are satisfied:
Curve has been detected
Curve radius>k₁₀ m, preferably >20 m
Oversteering has been detected
ESP is not activated
ABS is not activated.

In the case of partially-braked cornering, a start of the regulation preferably occurs if several of the following conditions are satisfied:
δ<f(ν) degree, δ<k₅ degrees, pₘₐᵢₙ>k₆ bar, ν>k₇ km/h,
α<k₈ degree, α_{actual}>k₉ m/s²,
with the threshold values k₅ to k₉ and ƒ(ν). The steering angle must fall below a threshold value, which is formed as a function of the speed. Empirical examinations here lead to three steering angle threshold values, which were in the range between 2 and 30 degree, and which were associated with vehicle speeds in the ranges 30 to 50 km/h, 100 to 140 km/h and 220 to 250 km/h.

As a condition for the detection of the end of a regulation situation it is provided that, in the case of partially-braked straight-ahead driving conditions, the end of corrective regulation of deviations from a desired lane occurs by setting or modifying the adjusted braking pressure, if at least one of the following conditions is satisfied
ESP is activated
ABS is activated
δ>k₁₁ degree,
δ>k₁₂ degrees,
   with the threshold values k₁₂ and k₁₁.

If the start conditions (activated regulation situation) are satisfied, but partially-braked straight-ahead driving conditions occur with termination of the activated regulation situation, without a correction or regulation of deviations from a certain driving lane having occurred, at least one of the following additional conditions must be satisfied:
δ>k degree,
δ>k₁ degree,
pₘₐᵢₙ<k₂ bar,
ν<k₃ km/h,
α>k₄ degree,
   straight-ahead driving conditions have not been detected.

As a condition for the detection of an end of a regulation situation, it is provided, that in the case of partially-braked cornering, the end of the corrective regulation of deviations from a desired driving lane occurs by setting or modifying the adjusted braking pressure, if at least one of the following conditions is satisfied:
ESP is activated
ABS is activated
δ>k₁₂ degrees.

If the start conditions (activated regulation situation) have been satisfied, but partially-braked cornering occurs with termination of the activated regulation system, with a corrective regulation of deviations from a desired lane having occurred, at least one of the following additional conditions must be satisfied:
δ>ƒ(ν), that is the steering angle is greater than a threshold value which is dependent on the vehicle speed, with linear interpolation between these reference places
δ>k₁₃ degrees,
pₘₐᵢₙ<k₁₄,
optionally as a function of the lateral acceleration
ν<k₁₅ km/h,
α>k₁₆ degree,
α_{actual}<k₁₇ m/s²,
curve radius<k₁₇ m, preferably <20 m
ESP is not activated, {ESP situation detection detects no cornering (constant or delayed)}
tₚ>k₁₈ s,
with threshold values k₁₃ to k₁₈ and ƒ(ν).

It is advantageous that no change in the adjustment of the braking pressure occurs if the following conditions have not been satisfied first:
ESP is not activated;
ABS is not activated;
Straight-ahead driving conditions have been detected.

The brake interventions, which are caused by the road stability regulation for the corrective regulation of deviations from the desired driving lane, advantageously occur by setting or modifying the adjusted braking pressure via a longitudinal force reduction by decreasing the pressure on at least one curve-interior wheel, preferably on the curve-interior back wheel. An advantageous variant of the LED method provides for the pressure decrease to occur on both curve-interior wheels.

While the set pressure difference on the front axle is compensated after the end of the regulation, the pressure difference which has been built up by the electronic brake force distribution (EBD) at the rear axle remains even after the regulation.

An embodiment example of the invention is represented in the drawings and described in greater detail below.

### BRIEF DESCRIPTION OF THE DRAWINGS

In the drawing:

FIG. 1 shows a vehicle with ESP regulation system;

FIG. 2 shows a status device which clarifies the activated or not activated regulation situations: partially-braked cornering, partially-braked straight-ahead driving conditions, and no regulation situation.

### DETAILED DESCRIPTION OF THE PREFERRED EMBODIMENTS

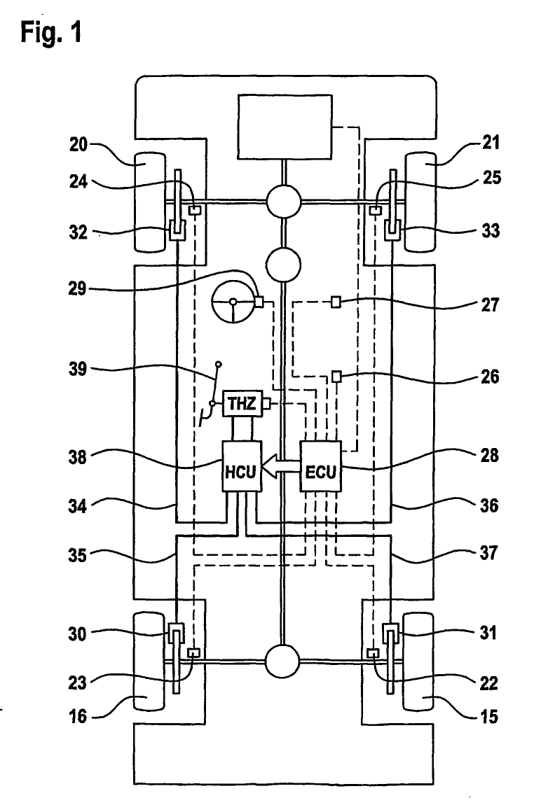

FIG. 1 is a vehicle with ESP regulation system, brake device, sensors and communication possibilities, in a schematic representation. The four wheels bear the reference numerals 15, 16, 20, and 21. On each of the wheels 15, 16, 20, 21, a wheel sensor 22, 23, 24, 25 is provided. The signals are applied to an electronic control unit 28, which determines, based on predetermined criteria, the vehicle speed v [sic; ν] from the rpm values of the wheels. Furthermore, a yaw rate sensor 26, a transverse acceleration sensor 27 and a steering wheel angle sensor 29 are connected with the component 28. In addition, each wheel presents an individually controllable wheel brake 30, 31, 32, 33. These brakes are operated hydraulically and they receive pressurized hydraulic fluid through the hydraulic lines 34, 35, 36, 37. The braking pressure is set via a valve block 38, where the value block is controlled by electrical signals, independently of the driver, which signals are generated in the electronic control unit 28. Via a main cylinder which is actuated by a brake pedal 39, the driver can request the application of a braking pressure in the hydraulic lines. The pressure sensors P are provided in the main cylinder and the hydraulic lines, respectively, by means of which the driver's intent to brake is detected. Via an interface (CAN), the electronic control unit is connected to the motor control unit.

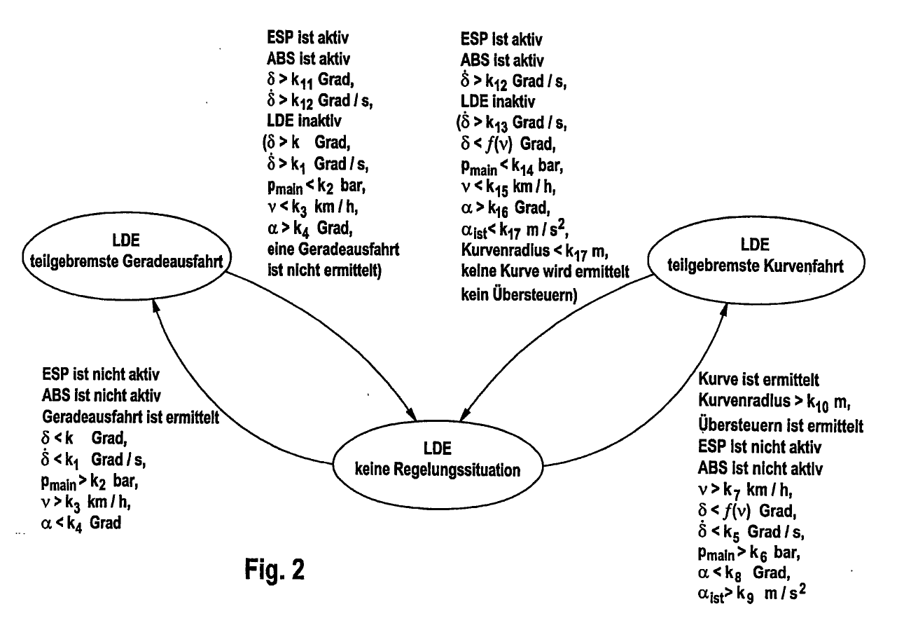

Via the ESP regulation system with brake device, sensory system and communication possibilities, which presents the equipment elements
four wheel rpm value sensors
pressure sensor (braking pressure in the main cylinder pₘₐᵢₙ)
lateral acceleration sensor (lateral acceleration signal α_{actual}, lateral inclination angle α)
yaw rate sensor (\dot{ψ})
steering wheel angle sensor (steering angle δ, steering angle speed \dot{δ})
individually controllable wheel brakes
hydraulic unit (HCU)
electronic control unit (ECU)
   a statement concerning the current driving situation can be obtained, and thereby an activated or not activated regulation system can be implemented via the start and end conditions. This allows the implementation of a main component of the LDE (low dynamic ESP) behavior, namely the driving situation detection, while the other main component, the interaction with the brake system, also makes use of the essential components of the ESP regulation system. In the situation detection, the ESP sensory system and the resulting measured and derived, internal and external, signal magnitudes are used to make a decision whether a typical driving situation for the LDS exists. Furthermore, verification is carried out to determine whether other partial systems of the ESP, or the ESP itself, already intervene via the brake system on the wheel brakes 30 to 33. In this case, the LDE regulation system remains passive, that is no regulation intervention occurs via the LDE process. The detection of the driving situation is based on the large steering angle (δ), steering angle speed (\dot{δ}), brake pressure (pₘₐᵢₙ), vehicle speed (ν), lateral inclination angle (α), lateral acceleration (α_{actual}), curve radius and the statuses of the ESP road stability regulation ESP activated, ABS activated, ESP not activated, ABS not activated, and, optionally, other functions such as, for example, those of hydraulic brake system. In the process, an activated or not activated regulation situation is determined as a function of a partially-braked straight-ahead driving condition and a partially-braked cornering. The structure of the status device is represented in FIG. 2. It has, as statuses, the control situations, LDE with partially-braked straight-ahead driving conditions and LDE with partially-braked cornering, as well as the rest situation “no regulation situation.” Each arrow in the diagram characterized a permissible status transition. This transition becomes activated, when the start and end conditions for a given regulation situation are satisfied. As a result of the unequivocal formulation and assignment of the regulation situations in a status device, no overlap between the function areas, or ambiguities can occur, and all the transitions also occur only in the prescribed form. As soon as one of the two activated LDE regulation situations has been reached, the post-connected LDE regulator is given the permission to start the regulation to correct or regulate the deviations from the desired driving lane. Because only one control situation occurs at that time, the same LDE regulator can be used for both statuses, that is the properties of the regulator can be changed as a function of this situation (for example start delay times, start and/or end thresholds (optionally also by means of a transverse acceleration-dependent projection)). The conditions for the transitions between statuses “LDE no regulation”>“LDE partially-braked straight-ahead driving conditions” and vice versa (start and end conditions) are described in greater detail below. In case of partially-braked straight-ahead conditions, several of the following conditions, preferably all, must be satisfied for an activated regulation situation (start): ESP is not activated, ABS is not activated, straight-ahead driving conditions have been detected,
   δ<k degree, δ<k₁ degrees, pₘₐᵢₙ>k₂ bar, ν>k₃ km/h,
   α<k₄ degree
   using the threshold values k to k₄, which are determined empirically.

The end of the activated control situation, with a corrective regulation of the deviation from a desired driving path, occurs if at least one of the conditions is satisfied:
ESP is activated
ABS is activated
δ>k₁₁ degree,
δ>k₁₂ degrees,
with threshold values k₁₁ and k₁₂.

If only one activated regulation situation occurs, without correction or control of the deviation from the desired driving path (LDE not activated), then the end of the activated regulation situation occurs, if at least one of the conditions is satisfied:
δ>k degree
δ>k₁ degree/s,
pₘₐᵢₙ<k₂ bar,
ν<k₃ km/h,
α>k₄ degree,
   straight-ahead driving conditions have not been detected.

In driving tests, it has been shown that the LDE regulator, for the regulation situation LDE in case of partially-braked cornering, requires more sensitive start thresholds than for the regulation situation LDE in case of partially-braked straight-ahead driving conditions. Below, the conditions for the transitions between the statuses “LDE no regulation situation” and “LDE partially-braked corner” are described. The conditions which are mentioned below for the start of the regulation situation “LDE partially-braked cornering” should preferably all be satisfied simultaneously (rounding off).

In partially-braked cornering, for the start of regulation to occur, several, preferably all, of the following conditions must be satisfied:

a) Standard ESP is not activated

b) ABS is not activated

c) Steering angle δ is smaller than the threshold value (as a function of the vehicle speed [δ<ƒ(ν)]), preferably three steering angle threshold values=(between 2 and 30 degrees) for the three speeds=(between 30 and 50 km/h, 100 and 140 km/h, 220 and 250 km/h) with linear interpolation between these reference values

d) steering angle speed \dot{δ} is smaller than the threshold value k₅

e) a driver applied preliminary pressure pₘₐᵢₙ is greater than the threshold value k₆, which can optionally be formed as a function of the transverse acceleration

f) vehicle speed ν is greater than the threshold value k₇

g) transverse inclination value α of the driving lane is smaller than the threshold value k₈

h) transverse acceleration α_{actual} is greater than the threshold value k₉

i) curve radius is grater than a threshold value k₁₀, preferably 20 m

j) ESP situation detects cornering (constant or delayed)

k) time after the beginning of the braking does not exceed a certain limit, preferably 3 seconds

For the precise formulation of the conditions b), different advantageous procedures are proposed. One possibility consists in allowing the start to occur only if, in general, the function ABS is activated at no wheel 15, 16, 20, 21. Furthermore, it would be possible to activate only if, at a given wheel, where the LDE wants to apply brake pressure modulation, the ABS function is not yet activated. It would also be possible to allow pressure modulation by LDE at an axle only if the ABS is not yet activated at the same axle.

In the case of partially-braked cornering, the end of the correction or regulation of deviations from a desired driving lane by setting or modifying the adjusted braking pressure occurs, if at least one of the following conditions is satisfied (one condition alone being satisfied is sufficient):
a) Standard ESP is activated
b) ABS is activated
c) Steering angle speed \dot{δ} is greater than the threshold value k₁₂ degree(s)

For the condition b), the above described conditions apply again. Provided the LDE regulator has not yet carried out a correction or regulation of a deviation from the desired driving lane, the conditions listed below apply, in addition to a) through c), for the end of the regulation situation to occur (for example, the case is possible where the start conditions of the regulation situations were satisfied, but later the regulation deviation which remains to be described fell below the start threshold of the LDE), where one of the following conditions has to be satisfied to end the activated regulation situation; [[.]]
l) steering angle δ is greater than a threshold value (ƒ(ν)), which is dependent on the vehicle speed, preferably three steering angle threshold values=(between 2 and 30 degree) for the three vehicle speed=(between 30 and 50 km/h, 100 and 140 km/h, 220 and 250 km/h) with linear interpolation between these two reference places)
d) steering angle speed \dot{δ} is greater than a threshold value k₁₃ degree/s
e) driver applied pressure pₘₐᵢₙ is smaller than the threshold value k₁₄, which can optionally be formed as a function of the lateral acceleration
f) vehicle speed ν is smaller than a threshold value k₁₅ km/h
g) lateral inclination value α of the driving lane is greater than a threshold value k₁₆ degree
h) lateral acceleration α_{actual} is smaller than a threshold value k₁₇ m/s²
i) curve radius is smaller than a threshold value k₁₇ (preferably 20 m).
j) ESP situation detection detects no cornering (constant or delayed)
k) time tₚ after the beginning of the braking exceeds a certain threshold value k₁₈ seconds

If the driving situation has been detected unequivocally, then the regulation can be carried out. As regulation magnitude, one uses the yaw rate \dot{ψ} of the vehicle here, whose deviation from the model desired behavior represents a measure of the deviation from the desired driving lane, which is to be reduced to a minimum. In comparison to the ESP yaw rate regulation, with the LDE, the intervention occurs already at substantially smaller deviations from the regulation. For this purpose, the ESP regulation threshold (S_{ESP}), which is formed based on ESP road stability criteria, is modified by the ESP road stability regulation, in the case of straight-ahead driving conditions by means of a first, and in the case of cornering by means of a second, correction factor (k_{STRAIGHT 1} k_{CURVE 2}).

In contrast to the conventional ESP regulation, in which the additional yaw moment (see DE 195 15 059 A1) is controlled by an activated pressure increase at the curve-exterior front wheel, with the Low Dynamic ESP (LDE) the stabilization of the vehicle occurs via longitudinal force reduction by pressure decrease at the curve-interior wheels. No activated pressure increase occurs. The selective pump control, which is used here and which functions only to prevent overfilling of the low-pressure reservoir, and the minimization of the value controls substantially improve the comfort level. The LDE activities can thus barely be perceived by the driver, so that the ESP function light also does not need to be switched on.

LDE interventions, as a rule, are designed similarly to ESP oversteering interventions. However, the pressure decrease in the LDE occurs simultaneously at both curve-interior wheels, where the main focus is on the possible decrease at the rear axle.

While the pressure difference which is set at the front axle is compensated after the end of the regulation, the pressure difference which has been built up at the rear axle by EBD persists even after the regulation.

The above mentioned decreases are applied as a function of the dynamics and the extent of the pulling. In addition, the LDE contains a number of measures to prevent unjustified regulations due to brief and permanent signal disturbances or incorrect detections.

To optimize the transitions from the LDE to the ESP, in view of achieving a more comfortable regulation, the start thresholds of the ESP are broadened, so that an ESP intervention occurs only in case of greater instabilities, which cannot be compensated by pressure decrease alone.

1. Method to improve the handling characteristic of a vehicle in case of partially-braked driving, characterized by a driving stability regulation to correct or regulate deviations from a desired driving lane, which is designed in such a manner that the start of an activated and the end of an activated regulation situation occurs as a function of conditions which are determined based on straight-ahead driving conditions and cornering.

2. Method according to claim 1, with the steps of detection of internal and external magnitudes and statuses, which represent the vehicle status parameters and the lane driving of the vehicle, detection of an activated regulation situation or the start of a regulation as a function of a straight-ahead driving condition or cornering, taking into account the internal and external magnitude and statuses, and correction and regulation of deviations from a desired driving lane by setting or modifying the adjusted braking pressure, when at least one threshold value is exceeded, which is determined based on the rotation above the vertical axis of the vehicle.

3. Method according to claim 1 or 2, characterized in that the internal and external magnitudes are compared with threshold values, and an evaluation of the statuses occurs in such a manner that a determination is made whether the statuses of driving stability regulation are deactivated or not activated.

4. Method according to claim 1, characterized in that the internal and external magnitudes and statuses, the driving angle (δ), the driving angle speed (\dot{δ}), the braking pressure (pₘₐᵢₙ), the vehicle speed (ν), the transverse inclination angle (α), the transverse acceleration (α_{actual}) the curve radius and regulation statuses of a vehicle stability regulation [sic].

5. Method according to claim 1, characterized in that the threshold value is determined based on the straight-ahead driving condition or cornering.

6. Method according to claim 3, characterized in that the threshold value of an ESP driving stability regulation is formed based on ESP driving stability criteria, and the threshold value (S_{ESP}), in case of a straight-ahead driving condition, is modified by means of a first, and, in case of cornering, by means of a second correction factor (k_{STRAIGHT 1} k_{CURVE 2}).

7. Method according to one of claims 1 to 4, characterized in that in the case of a partially-braked straight-ahead driving conditions, the start Gᵢₙ of regulation occurs based on the relation Gᵢₙ=ƒ(δ, \dot{δ}, pₘₐᵢₙ, ν, α) if one or more of the following conditions are satisfied:
ESP is not activated
ABS is not activated
Straight-ahead driving conditions have been detected.

8. Method according to claim 7, characterized in that, in case of a partially-braked straight-ahead driving condition, the start of regulation occurs, if several of the following conditions are satisfied:
δ<k degree, δ<k₁ degree/s, pₘₐᵢₙ<k₂ bar, ν<k₃ km/h,
α<k₄ degree,
with the threshold values k to k₄.

9. Method according to one of claims 1 to 4, characterized in that in partially-braked cornering, the start Kin of regulation occurs according to the relation Kᵢₙ=ƒ(δ, δ, pₘₐᵢₙ, ν, α, α_{actual}), if one or more of the following conditions are satisfied:
Curve is detected
Curve radius>k₁₀ m, preferably >20 m
Oversteering not detected
ESP is not activated
ABS is not activated

10. Method according to claim 9, characterized in that, in partially-braked cornering, the start of the regulation occurs, if several of the following conditions are satisfied:
δ<f(ν) degree, δ<k₅ degrees, pₘₐᵢₙ>k₆ bar, ν>k₇ km/h,
α<k₈ degree, α_{actual}>k₉ m/s²,
with the threshold values k₅ to k₉ and ƒ(ν).

11. Method according to one of claims 1 to 5, characterized in that, in partially-braked straight-ahead driving, the end of the correction or regulation of deviations from a desired driving lane occurs by setting or modifying the adjusted braking pressure, if at least one of the following conditions is satisfied
ESP is activated
ABS is activated
δ>k₁₁ degree,
δ>k₁₂ degree/s,
with the threshold values k₁₂ and k₁₁

12. Method according to claim 11, characterized in that during partially-braked straight-ahead driving, the end of the activated regulation separation occurs, without any correction or regulation of deviations from a desired driving lane having occurred, if at least one of the following addition conditions is satisfied:
δ>k degree,
δ>k₁ degree/s,
pₘₐᵢₙ<k₂ bar,
ν<k₃ km/h,
α>k₄ degree,
Straight-ahead driving conditions have not been detected.

13. Method according to one of claims 1 to 4 or 6, characterized in that, during partially-braked cornering, the end of the correction or regulation of deviations from a desired driving lane by setting or modifying the adjusted braking pressure occurs, if at least one of the following conditions is satisfied:
ESP is activated
ABS is activated
δ>k₁₂ degree/s.

14. Method according to claim 12, characterized in that during partially-braked cornering the end of the activated regulation situation occurs, without a correction or regulation of deviations from a desired driving lane having taken place, if at least one of the following additional conditions is satisfied:
δ>ƒ(ν), that is the steering angle is greater than a threshold value which is dependent on the vehicle speed,
with linear interpolation between these reference place
δ>k₁₃ degree/s,
pₘₐᵢₙ<k₁₄, optionally as a function of the transverse acceleration
ν<k₁₅ km/h,
α>k₁₆ degree,
α_{actual}<k₁₇ m/s²,
Curve radius<k₁₇ m, preferably <20 m
ESP is not activated, {ESP situation detection detects no cornering (constant or delayed)}
tₚ>k₁₈ s,
with the threshold values k₁₃ and k₁₈ and ƒ(ν).

15. Method according to one of claims 1 to 13, characterized in that no setting or modification of the braking pressure occurs, if the conditions according to claims 7, 8 or 9, 10 have not been satisfied first.

16. Method according to one of claims 1 to 10, characterized in that, the correction or regulation of deviations from the desired driving lane by setting or modifying the adjusted braking pressure occurs via a longitudinal force reduction by pressure decrease on at least one curve-interior wheel, preferably on the curve-interior back wheel.

17. Method according to claim 15, characterized in that the pressure decrease occurs on both curve-interior wheels.

18. Method according to one of claims 1 to 16, characterized in that the pressure difference which is set by the pressure decrease at the rear axle by the electronic brake force distribution (EBD) is maintained.
